(19) United States
(12) Patent Application Publication
(10) Pub. No.: US 2008/0295007 A1
(43) Pub. Date: Nov. 27, 2008

(54) Data Visualization

(75) Inventor: Gregory L. Bernhardt, Boise, ID (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/753,070

(22) Filed: May 24, 2007

(51) Int. Cl. G06F 3/048

(52) U.S. Cl. 715/764

(57) ABSTRACT

Data visualization may be provided. First, a data cell may be displayed. Then a request may be received to expand the data cell into a plurality of sub-cells. A sum of the data corresponding to the plurality of sub-cells may equal a value corresponding to the data cell. Next, a number of sub-cells in the plurality of sub-cells may be determined. Then, a graphical representation of data corresponding to the plurality of sub-cells may be displayed when the determined number of sub-cells in the plurality of sub-cells is greater than a predetermined value. The graphical representation may be displayed in place of the data cell. Next, information corresponding to the plurality of sub-cells may be displayed when a user selectable element hovers over the graphical representation.

### RELATED APPLICATION

Related U.S. patent application Ser. No ______, filed on even date herewith in the name of Greg ______. Bernhardt and entitled “Data Relevance Filtering,” assigned to the assignee of the present application, is hereby incorporated by reference.

### BACKGROUND

Business intelligence (BI) is a business management term that refers to applications and technologies that are used to gather, provide access to, and analyze data and information about business operations. Business intelligence systems can help companies have a more comprehensive knowledge of the factors affecting their business, such as metrics on sales, production, internal operations, and they can help companies make better business decisions.

Business intelligence applications and technologies can enable organizations to make more informed business decisions, and they may give a company a competitive advantage. For example, a company could use business intelligence applications or technologies to extrapolate information from indicators in the external environment and forecast the future trends in their sector. Business intelligence is used to improve the timeliness and quality of information and enable managers to better understand the position of their company in comparison to its competitors.

Business intelligence applications and technologies can help companies analyze the following: changing trends in market share, changes in customer behavior and spending patterns, customers' preferences, company capabilities and market conditions. Business intelligence can be used to help analysts and managers determine which adjustments are most likely to affect trends.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Data visualization may ha provided. First, a data cell may be displayed. Then a request may be received to expand the data cell into a plurality of sub-cells. A sum of the data corresponding to the plurality of sub-cells may equal a value corresponding to the data cell. Next, a number of sub-cells in the plurality of sub-cells may be determined. Then, a graphical representation of data corresponding to the plurality of sub-cells may be displayed when the determined number of sub-cells in the plurality of sub-cells is greater than a predetermined value. The graphical representation may be displayed in place of the data cell. Next, information corresponding to the plurality of sub-cells may be displayed when a user selectable element hovers over the graphical representation.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a diagram showing output of a BI application;

FIG. 2 is a flow chart of a method for providing data visualization;

FIG. 3 is a diagram showing output providing data visualization; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

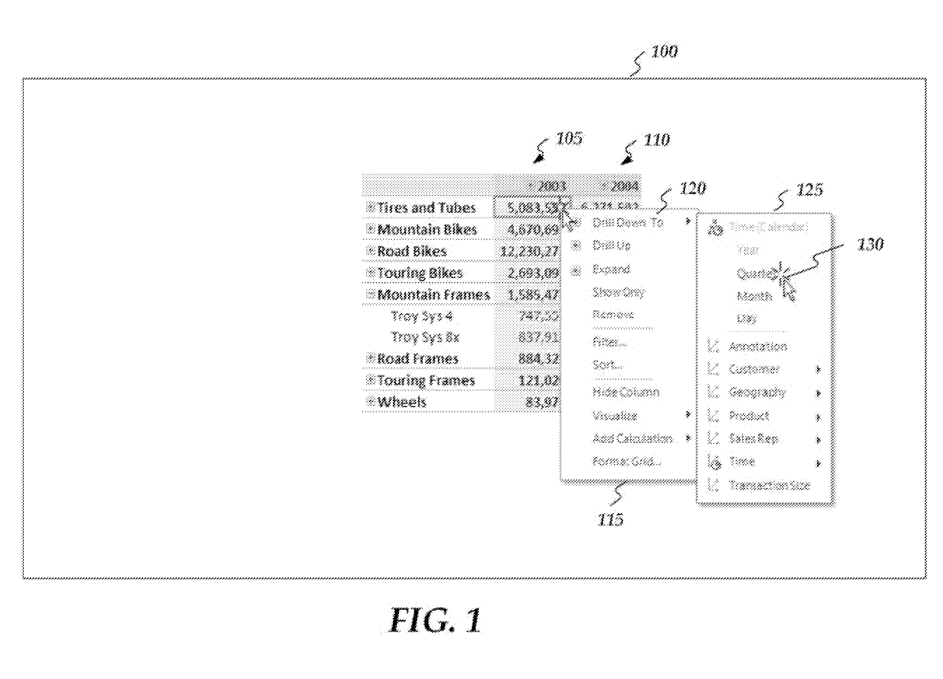

FIG. 1 is a diagram showing output of a BI application. When a user navigates through a data set, the user may “drill down” into a large number of data points. When these data points are a group of contiguous time members (e.g. twelve months of data) conventional systems show those twelve months numerically. This takes a lot of space on a computer screen to show the twelve months numerically and does not help the user understand value trends.

Embodiments of the invention may change the visualization of the data columns automatically when certain types of dimensions am navigated. For example, when the user navigates into a “large” set of contiguous time data, the data may be shown as a “sparkline” instead of discrete columns consistent with embodiments of the invention. A sparkline may comprise an effective way of showing data in a time series. Consequently, embodiments of the invention may show other types of visualizations when navigating from a small data set into a certain type of large data set. For example, embodiments of the invention may show a sparkline when a time dimension is navigated.

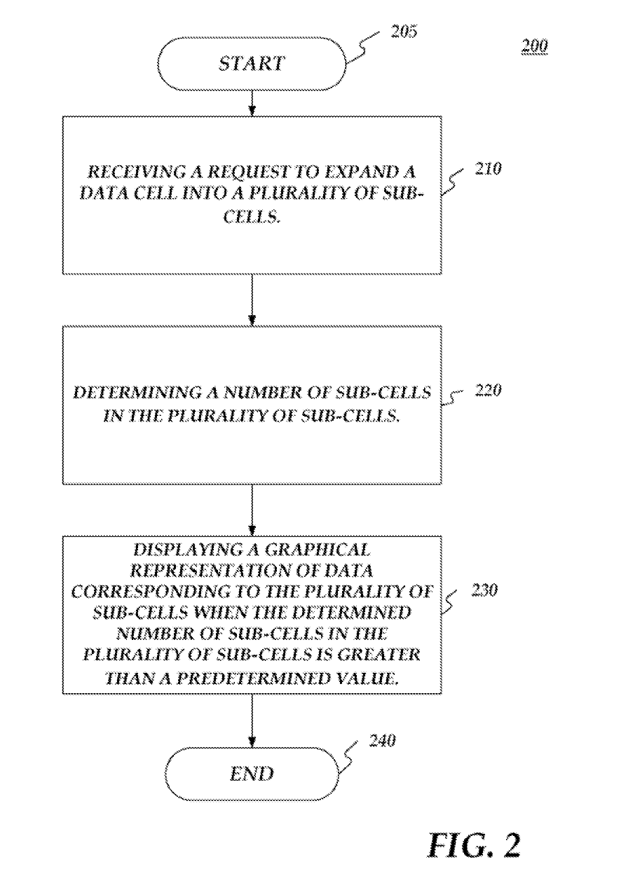

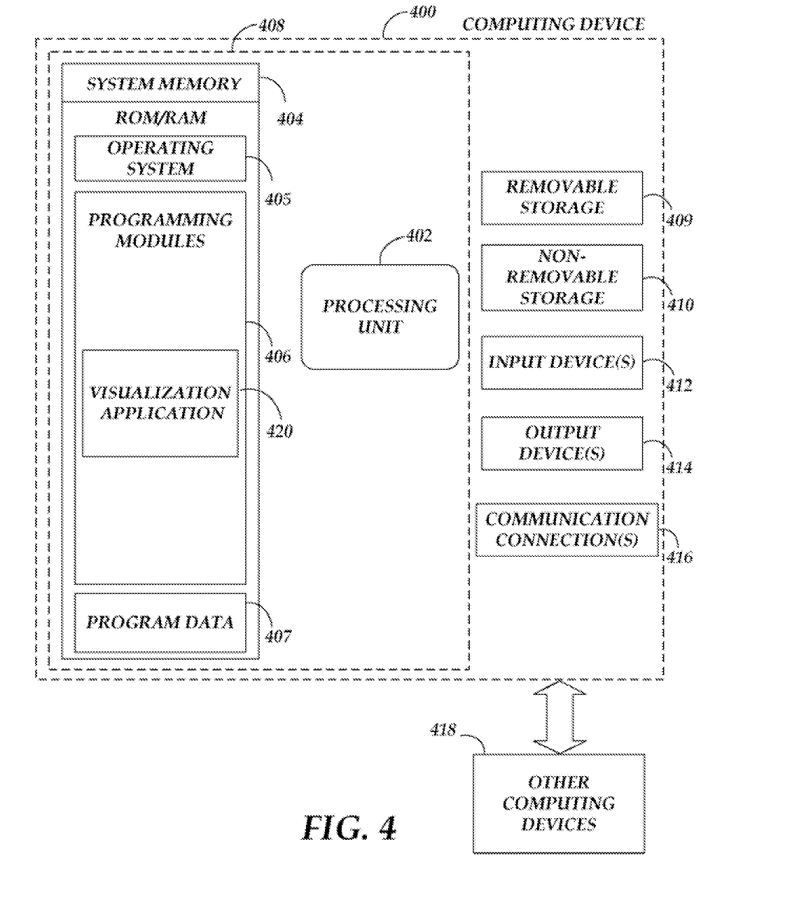

FIG. 2 is a flow chart setting forth the general stages involved in a method 200 consistent with an embodiment of the invention for providing data visualization. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may receive a request to expand a data cell into a plurality of sub-cells. For example, a user may be viewing a first sales figure column 105 and a second sales figure column 110 shown on a first screen 100 displayed, for example, on a display device (e.g. an output device 414 as described below). In order to see the sales figures of column 105 in more detail (e.g. “drilled down”), the user may select (e.g. with input device 412 as described below) a first window 115 from a tool bar (not shown). Upon viewing first window 115, the user may select a first user selectable element 120 in order to “drill down” into the data shown in column 105. In response to first user selectable element 120 being selected, computing device 400 may display a second window 125. From second window 125, the user may choose to see data from first sales figure column 105 in a quarterly granularity by selecting a second user selectable element 130, for example.

From stage 210, where computing device 400 receives the request to expand the data cell into the plurality of sub-cells, method 200 may advance to stage 220 where computing device 400 may determine a number of sub-cells in the plurality of sub-cells. For example, the user may have selected a quarterly granularity by selecting second user selectable element 130 as described above. Because the selected granularity is quarterly, data in each of the cells in first sales figure column 105 should be broken down by computing device 400 into four separate cells, each respectfully corresponding to sales in the quarter of 2003 in which sales were made. In other words, first sales figure column 105 being yearly, may be broken down into a quarterly granularity. Consequently, in the year-to-quarterly example, the number sub-cells in the plurality of sub-cells may be four. In another example, in a yearly-to-monthly example, the number sub-cells in the plurality of sub-cells may be twelve. Furthermore, in a yearly-to-daily example, the number of sub-cells in the plurality of sub-cells may be 365. Moreover, in a monthly-to-daily example, the plurality of sub-cells may be thirty. Notwithstanding any typo of time subdivision may be used.

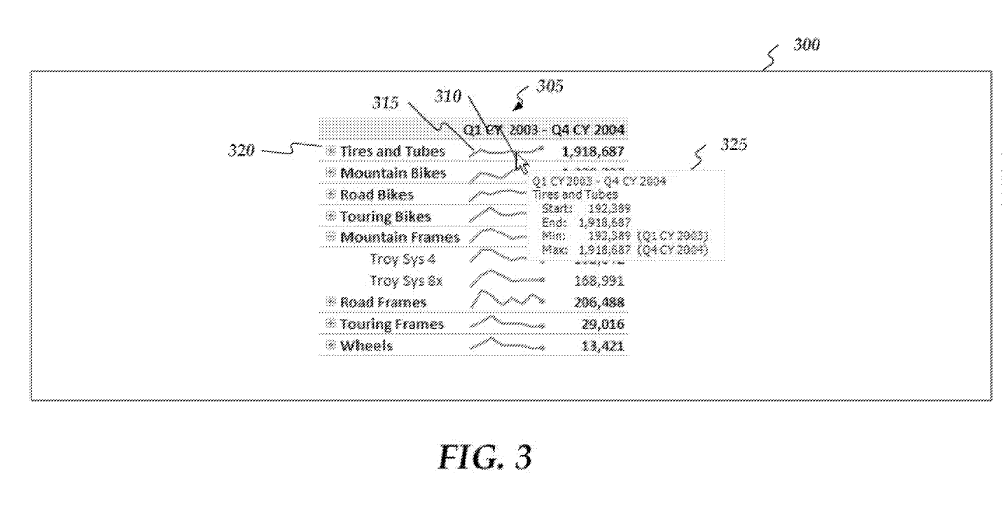

Once computing device 400 determines the number of sub-cells in the plurality of sub-cells in stage 220, method 200 may continue to stage 230 where computing device 400 may display a graphical representation of data corresponding to the plurality of sub-cells when the determined number of sub-cells in the plurality of sub-cells is greater than a predetermined value. For example, the user may find that when a “drilling down” operation causes four or more columns to be displayed from an existing column, the user is confused by the corresponding amount of date. As a result, the user may set the predetermined value in application 420 to four. In other words, during a set-up of application 420, the user may set the predetermined value at four for example. As a result, when the user selects second user selectable element 130 (e.g. quarterly,) rather than displaying four quarterly data columns correspond to first sales figure column 105, computing device 400 may display graphical representations 305 of the data in first sales figure column 105 as shown in a second screen 300 of FIG. 3. For example, a separate graphical representation for each row in first sales figure column 105 may be displayed in place of the data from column 105 corresponding to the respective graphical representation. The graphical representations may comprise, but are not limited to, “sparklines.”

Moreover, when the user causes, for example, a mouse pointer 310 to “hover” over any one of graphical representations 305, computing device 400 may display information corresponding to the plurality of sub-cells. For example, when the user causes mouse pointer 310 to hover over a sparkline 315 (e.g. corresponding to “tires and tubes” row 320), an information window 325 may be displayed. Data displayed in information window 325 may comprise, but is not limited to, a starting value of the data corresponding to sparkline 315, an ending value of the data corresponding to sparkline 315, a minimum value of the data corresponding to sparkline 315, and a maximum value of the data corresponding to sparkline 315. Once computing device 400 displays the graphical representation in stage 230, method 200 may then end at stage 240.

An embodiment consistent with the invention may comprise a system for providing data visualization. The system may comprise a memory storage and a processing unit coupled to the memory storage. The processing unit may be operative to receive a request to expand a data cell into a plurality of sub-cells and to determine a number of sub-cells in the plurality of sub-cells. Furthermore, the processing unit may be operative to display a graphical representation of data corresponding to the plurality of sub-cells when the determined number of sub-cells in the plurality of sub-cells is greater than a predetermined value.

Another embodiment consistent with the invention may comprise a system for providing data visualization. The system may comprise a memory storage and a processing unit coupled to the memory storage. The processing unit may be operative to display a data cell and to receive a request to expand the data cell into a plurality of sub-cells. In addition, the processing unit may be operative to determine a number of sub-cells in the plurality of sub-cells. Moreover, the processing unit may be operative to display a graphical representation of data corresponding to the plurality of sub-cells when the determined number of sub-cells in the plurality of sub-cells is greater than a predetermined value.

Yet another embodiment consistent with the invention may comprise a system for providing data visualization. The system may comprise a memory storage and a processing unit coupled to the memory storage. The processing unit may be operative to display a data cell. In addition, the processing unit may he operative to receive a request to expand the data cell into a plurality of sub-cells. A sum of the data corresponding to the plurality of sub-cells may be equal to a value corresponding to the data cell. Furthermore, the processing unit may be operative to determine a number of sub-cells in the plurality of sub-cells. Moreover, the processing unit may be operative to display a graphical representation of data corresponding to the plurality of sub-cells when the determined number of sub-cells in the plurality of sub-cells is greater than a predetermined value, the graphical representation being displayed in place of the dale cell and comprising a sparkline. Also, the processing unit may be operative to display information corresponding to the plurality of sub-cells when a user selectable element hovers over the graphical representation.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above. System 100 may operate in other environments and is not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, hut is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include, for example data visualization application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. data visualization application 420) may perform processes including, for example, one or more method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a earner readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionally/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

1. A method for providing data visualization, the method comprising:
receiving a request to expand a data cell into a plurality of sub-cells;
determining a number of sub-cells in the plurality of sub-cells; and
displaying a graphical representation of data corresponding to the plurality of sub-cells when the determined number of sub-cells in the plurality of sub-cells is greater than a predetermined value.

2. The method of claim 1, further comprising displaying the data cell.

3. The method of claim 2, wherein displaying the graphical representation comprises displaying the graphical representation in place of the data cell.

4. The method of claim 1, further comprising displaying information corresponding to the plurality of sub-cells when a user selectable element hovers over the graphical representation.

5. The method of claim 1, further comprising displaying information corresponding to the plurality of sub-cells when a user selectable element hovers over the graphical representation, the displayed information comprising at least one of the following: a starting value of the data corresponding to the plurality of sub-cells, an ending value of the data corresponding to the plurality of sub-cells, a minimum value of the data corresponding to the plurality of sub-cells, and a maximum value of the data corresponding to the plurality of sub-cells.

6. The method of claim 1, wherein receiving the request to expand the data cell into the plurality of sub-cells comprises receiving the request to expand the data cell into the plurality of sub-cells wherein a sum of the data corresponding to the plurality of sub-cells equals a value corresponding to the data cell.

7. The method of claim 1, wherein receiving the request to expand the data cell into the plurality of sub-cells comprises receiving the request to expand the data cell into the plurality of sub-cells wherein the plurality of sub-cells correspond to time subdivisions of the data cell.

8. The method of claim 1, wherein receiving the request to expand the data cell into the plurality of sub-cells comprises receiving the request to expand the data cell into the plurality of sub-cells wherein the data cell corresponds to yearly data and the plurality of sub-cells correspond to one of the following: quarterly data, monthly data, bi-monthly data, daily data, and hourly data.

9. The method of claim 1, wherein displaying the graphical representation of the data corresponding to the plurality of sub-cells when the determined number of sub-cells in the plurality of sub-cells is greater than the predetermined value comprises displaying the graphical representation of the data corresponding to the plurality of sub-cells when the determined number of sub-cells in the plurality of sub-cells is greater than the predetermined value comprising one of the following: greater than five and equal to five.

10. The method of claim 1, wherein displaying the graphical representation of the data corresponding to the plurality of sub-cells when the determined number of sub-cells in the plurality of sub-cells is greater than the predetermined value comprises displaying the graphical representation of the data corresponding to the plurality of sub-cells when the determined number of sub-cells in the plurality of sub-cells is greater than the predetermined value being user selected.

11. A computer-readable medium which stores a set of instructions which when executed performs a method for providing data visualization, the method executed by the set of instructions comprising:
displaying a data cell;
receiving a request to expand the data cell into a plurality of sub-cells;
determining a number of sub-cells in the plurality of sub-cells; and
displaying a graphical representation of data corresponding to the plurality of sub-cells when the determined number of sub-cells in the plurality of sub-cells is greater than a predetermined value.

12. The computer-readable medium of claim 11, wherein displaying the graphical representation comprises displaying the graphical representation in place of the data cell.

13. The computer-readable medium of claim 11, further comprising displaying information corresponding to the plurality of sub-cells when a user selectable element hovers over the graphical representation.

14. The computer-readable medium of claim 11, further comprising displaying information corresponding to the plurality of sub-cells when a user selectable element hovers over the graphical representation, the displayed information comprising at least one of the following: a staring value of the data corresponding to the plurality of sub-cells, an ending value of the data corresponding to the plurality of sub-cells, a minimum value of the data corresponding to the plurality of sub-cells, and a maximum value of the data corresponding to the plurality of sub-cells.

15. The computer-readable medium of claim 11, wherein receiving the request to expand the data cell into the plurality of sub-cells comprises receiving the request to expand the data cell into the plurality of sub-cells wherein a sum of the data corresponding to the plurality of sub-cells equals a value corresponding to the data cell.

16. The computer-readable medium of claim 11, wherein receiving the request to expand the data cell into the plurality of sub-cells comprises receiving the request to expand the data cell into the plurality of sub-cells wherein the plurality of sub-cells correspond to time subdivisions of the data cell.

17. The computer-readable medium of claim 11, wherein receiving the request to expand the data cell into the plurality of sub-cells comprises receiving the request to expand the data cell into the plurality of sub-cells wherein the data cell corresponds to yearly data and the plurality of sub-cells correspond to one of the following: quarterly data, monthly data, bi-monthly data, daily data, and hourly data.

18. The computer-readable medium of claim 11, wherein displaying the graphical representation of the data corresponding to the plurality of sub-cells when the determined number of sub-cells in the plurality of sub-cells is greater than the predetermined value comprises displaying the graphical representation of the data corresponding to the plurality of sub-cells when the determined number of sub-cells in the plurality of sub-cells is greater than the predetermined value comprising one of the following: greater than five and equal to five.

19. The computer-readable medium of claim 11, wherein displaying the graphical representation of the data corresponding to the plurality of sub-cells when the determined number of sub-cells in the plurality of sub-cells is greater than the predetermined value comprises displaying the graphical representation of the data corresponding to the plurality of sub-cells when the determined number of sub-cells in the plurality of sub-cells is greater than the predetermined value being user selected.

20. A system for providing data visualization, the system comprising:
a memory storage; and
a processing unit coupled to the memory storage, wherein the processing unit is operative to:
display a data cell;
receive a request to expand the data cell into a plurality of sub-cells wherein a sum of the data corresponding to the plurality of sub-cells equals a value corresponding to the data cell;
determine a number of sub-cells in the plurality of sub-cells;
display a graphical representation of data corresponding to the plurality of sub-cells when the determined number of sub-cells in the plurality of sub-cells is greater than a predetermined value, the graphical representation being displayed in place of the data cell and comprising a sparkline; and
display information corresponding to the plurality of sub-cells when a user selectable element hovers over the graphical representation.
